(19) United States
(12) Patent Application Publication
(10) Pub. No.: US 2014/0250628 A1
(43) Pub. Date: Sep. 11, 2014

(54) Castor for Luggage

(71) Applicant: Po-Chuan Tsai, Tainan City (TW)

(72) Inventor: Po-Chuan Tsai, Tainan City (TW)

(21) Appl. No.: 13/784,940

(22) Filed: Mar. 5, 2013

(51) Int. Cl. B60B 33/00

(52) U.S. Cl. CPC B60B 33/0007; B60B 33/0042
USPC 16/47

(57) ABSTRACT

A castor for a luggage includes a mounting seat, an upright mandrel having an upper portion connected with the mounting seat, a roller support mounted on a lower portion of the upright mandrel, a shaft mounted on the roller support, and two rollers secured on two opposite ends of the shaft and located at two opposite side of the roller support. Thus, when the rollers on the roller support are worn out during a long-term utilization, the roller support can be removed from the upright mandrel for maintenance or replacement of the roller support and the rollers, without having to replace the whole structure of the castor.

### BACKGROUND OF THE INVENTION

1. Field of the Invention

The present invention relates to a wheeled vehicle and, more particularly, to a castor for a luggage, chair, cart and the like.

2. Description of the Related Art

A conventional castor 1 for a luggage in accordance with the prior art shown in FIG. 1 comprises a mounting seat 10, a washer 17 mounted on the mounting seat 10, a roller support 11 rotatably mounted on the mounting seat 10, a connecting member 13 mounted between the mounting seat 10 and the roller support 11, a ball bearing 16 located between the mounting seat 10 and the roller support 11, an upper spacer 14 mounted between the mounting seat 10 and the ball bearing 16, a lower spacer 15 mounted between the ball bearing 16 and the roller support 11, and two rollers 12 mounted on two opposite side of the roller support 11 respectively. The connecting member 13 is in turn extended through the roller support 11, the lower spacer 15, the ball bearing 16, the upper spacer 14, the mounting seat 10 and the washer 17, and is secured on the mounting seat 10 by riveting. Thus, the roller support 11 is rotatable relative to the mounting seat 10. However, the roller support 11 and the mounting seat 10 are combined integrally by the connecting member 13 and cannot be detached from each other, so that when one of the rollers 12 is worn out during a long-term utilization, the roller support 11 and the rollers 12 cannot be replaced independently, and the user has to replace the whole structure of the castor 1, thereby increasing the cost of maintenance and replacement.

### BRIEF SUMMARY OF THE INVENTION

In accordance with one embodiment of the present invention, there is provided a castor for a luggage, comprising a mounting seat, an upright mandrel having an upper portion connected with the mounting seat, a roller support mounted on a lower portion of the upright mandrel, a fastening member extended through the roller support and locked onto the lower portion of the upright mandrel to combine the roller support with the upright mandrel, a shaft mounted on the roller support, and two rollers secured on two opposite ends of the shaft and located at two opposite side of the roller support. The mounting seat is provided with an upright through hole. The roller support is provided with a shaft hole. The roller support has a top provided with a receiving hole. The roller support has a bottom provided with a screw bore which is connected to the receiving hole. The shaft is extended through the shaft hole of the roller support. The upper portion of the upright mandrel is extended through the through hole of the mounting seat and is secured on the mounting seat so that the upright mandrel is combined with the mounting seat. The lower portion of the upright mandrel is inserted into the receiving hole of the roller support. The lower portion of the upright mandrel is provided with a threaded recess aligning with the screw bore of the roller support. The fastening member is extended through the screw bore of the roller support and is screwed into the threaded recess of the upright mandrel so that the roller support is combined with the upright mandrel and is rotatable relative to the upright mandrel.

In accordance with another embodiment of the present invention, there is provided a castor for a luggage, comprising a mounting seat, an upright mandrel having an upper portion connected with the mounting seat, a roller support mounted on a lower portion of the upright mandrel, a shaft mounted on the roller support, and two rollers secured on two opposite ends of the shaft and located at two opposite side of the roller support. The mounting seat is provided with an upright through hole. The roller support is provided with a shaft hole. The roller support has a top provided with a receiving hole. The receiving hole of the roller support is provided with a flange. The shaft is extended through the shaft hole of the roller support. The upper portion of the upright mandrel is extended through the through hole of the mounting seat, and is secured on the mounting seat so that the upright mandrel is combined with the mounting seat. The lower portion of the upright mandrel is inserted into the receiving hole of the roller support. The lower portion of the upright mandrel is provided with a groove detachably locked onto the flange of the roller support.

The primary objective of the present invention is to provide a castor whose roller support can be detached independently when the rollers on the roller support are worn out so as to replace the roller support and the rollers.

According to the primary advantage of the present invention, when the rollers are worn out during a long-term utilization, the fastening member is detached from the roller support and the upright mandrel to unlock the roller support from the upright mandrel so that the roller support can be removed from the upright mandrel for maintenance or replacement of the roller support and the rollers, without having to replace the whole structure of the castor, thereby decreasing the cost of replacement and maintenance.

According to another advantage of the present invention, the user only needs to unscrew the fastening member to detach the roller support from the upright mandrel so that the user can replace the roller support and the rollers easily and conveniently.

According to a further advantage of the present invention, the stepped portion of the stub of each of the rollers abuts the respective mounting recess of the roller support, so that each of the rollers is combined with the roller support tightly and closely so as to prevent dust or dirt from entering the clearance between the roller support and each of the rollers.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side cross-sectional view of a conventional castor for a luggage in accordance with the prior art.

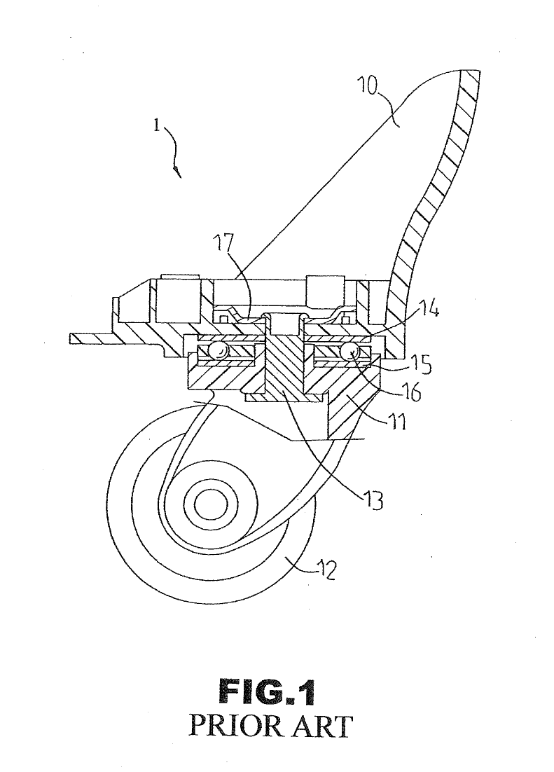

FIG. 2 is a perspective view of a castor for a luggage in accordance with the preferred embodiment of the present invention.

FIG. 3 is an exploded perspective view of the castor for a luggage as shown in FIG. 2.

FIG. 4 is a side cross-sectional view of the castor for a luggage taken along line 4-4 as shown in FIG. 2.

FIG. 5 is a front cross-sectional view of the castor for a luggage taken along line 5-5 as shown in FIG. 2.

FIG. 6 is a perspective view of a castor for a luggage in accordance with another preferred embodiment of the present invention.

FIG. 7 is an exploded perspective view of the castor for a luggage as shown in FIG. 6.

FIG. 8 is a side cross-sectional view of the castor for a luggage taken along line 8-8 as shown in FIG. 6.

FIG. 9 is a front cross-sectional view of the castor for a luggage taken along line 9-9 as shown in FIG. 6.

### DETAILED DESCRIPTION OF THE INVENTION

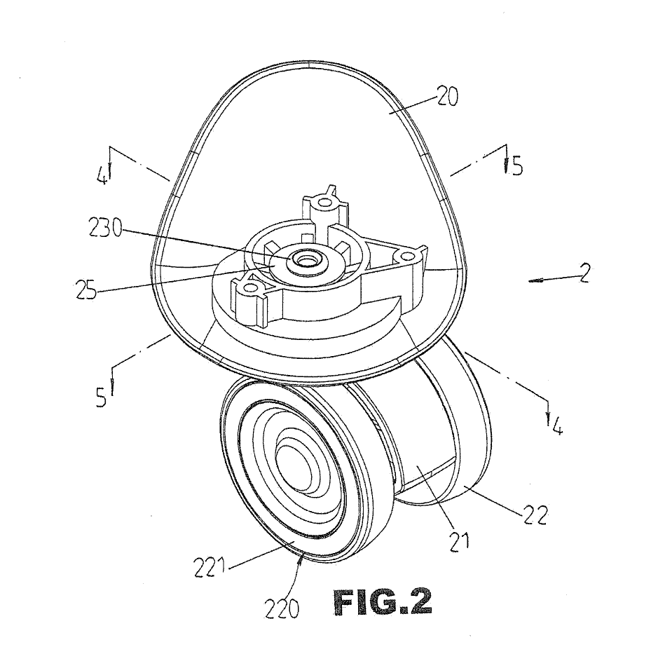

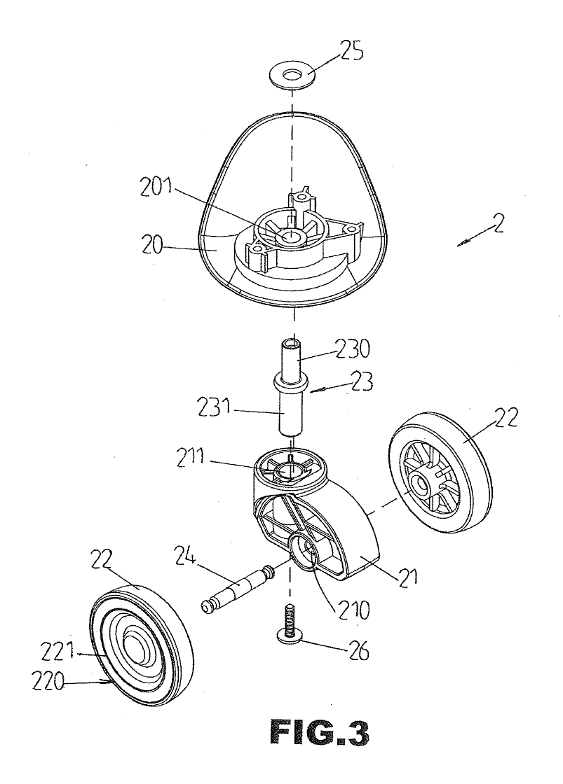

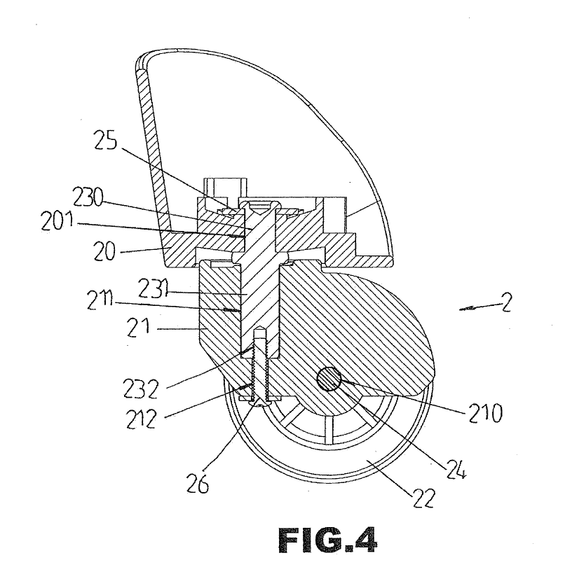

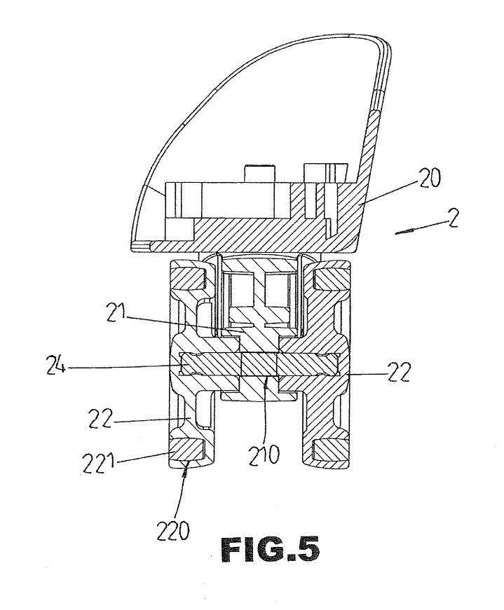

Referring to the drawings and initially to FIGS. 2-5, a castor 2 for a luggage in accordance with the preferred embodiment of the present invention comprises a mounting seat 20, an upright mandrel 23 having an upper portion 230 connected with the mounting seat 20, a roller support 21 mounted on a lower portion 231 of the upright mandrel 23, a fastening member 26 extended through the roller support 21 and locked onto the lower portion 231 of the upright mandrel 23 to combine the roller support 21 with the upright mandrel 23, a shaft 24 mounted on the roller support 21, and two rollers 22 secured on two opposite ends of the shaft 24 and located at two opposite side of the roller support 21.

The mounting seat 20 has a central portion provided with an upright through hole 201. The roller support 21 is provided with a shaft hole 210 which is extended in a transverse direction of the roller support 21. The roller support 21 has a top provided with a receiving hole 211 which is extended in the vertical direction. The roller support 21 has a bottom provided with a screw bore 212 which is connected to the receiving hole 211. The screw bore 212 of the roller support 21 is located at a central portion of and coaxial with the receiving hole 211. The shaft 24 is extended through the shaft hole 210 of the roller support 21.

The upper portion 230 of the upright mandrel 23 is in turn extended through the through hole 201 of the mounting seat 20 and a washer 25. The upper portion 230 of the upright mandrel 23 is secured on the mounting seat 20 by riveting so that the upright mandrel 23 is combined with the mounting seat 20. The lower portion 231 of the upright mandrel 23 is inserted into the receiving hole 211 of the roller support 21. The lower portion 231 of the upright mandrel 23 is provided with a threaded recess 232 aligning with the screw bore 212 of the roller support 21. The threaded recess 232 of the upright mandrel 23 is formed in a central portion of a bottom of the lower portion 231 of the upright mandrel 23.

Each of the rollers 22 has an outer face provided with an annular retaining groove 220 for mounting a resilient gasket 221 which is made of a soft material.

The fastening member 26 is preferably a bolt. The fastening member 26 is extended through the screw bore 212 of the roller support 21 and is screwed into the threaded recess 232 of the upright mandrel 23 so that the roller support 21 is combined with the upright mandrel 23 and is rotatable relative to the upright mandrel 23. The fastening member 26 is detachably locked onto the roller support 21 and the upright mandrel 23 so that the fastening member 26 is detachable from the roller support 21 and the upright mandrel 23 to detach the roller support 21 from the upright mandrel 23.

In assembly, the shaft 24 is initially extended through the shaft hole 210 of the roller support 21. Then, the rollers 22 are secured on the two opposite ends of the shaft 24 and are located at the two opposite side of the roller support 21. Then, the upper portion 230 of the upright mandrel 23 is in turn extended through the through hole 201 of the mounting seat 20 and the washer 25, and is secured on the mounting seat 20 by riveting so that the upright mandrel 23 is combined with the mounting seat 20. Then, the lower portion 231 of the upright mandrel 23 is inserted into the receiving hole 211 of the roller support 21, with the threaded recess 232 being aligned with the screw bore 212 of the roller support 21. Then, the fastening member 26 is extended through the screw bore 212 of the roller support 21 and is screwed into the threaded recess 232 of the upright mandrel 23 so that the roller support 21 is combined with the upright mandrel 23. At this time, the roller support 21 is rotatable relative to the upright mandrel 23. In such a manner, the roller support 21 is combined with the mounting seat 20 by the upright mandrel 23 to construct the castor 2.

When one of the rollers 22 is worn out, the fastening member 26 is unscrewed and detached from the roller support 21 and the upright mandrel 23 to unlock the roller support 21 from the upright mandrel 23 so that the roller support 21 can be removed from the upright mandrel 23 for maintenance or replacement of the roller support 21 and the rollers 22.

Accordingly, when the rollers 22 are worn out during a long-term utilization, the fastening member 26 is detached from the roller support 21 and the upright mandrel 23 to unlock the roller support 21 from the upright mandrel 23 so that the roller support 21 can be removed from the upright mandrel 23 for maintenance or replacement of the roller support 21 and the rollers 22, without having to replace the whole structure of the castor 2, thereby decreasing the cost of replacement and maintenance. In addition, the user only needs to unscrew the fastening member 26 to detach the roller support 21 from the upright mandrel 23 so that the user can replace the roller support 21 and the rollers 22 easily and conveniently.

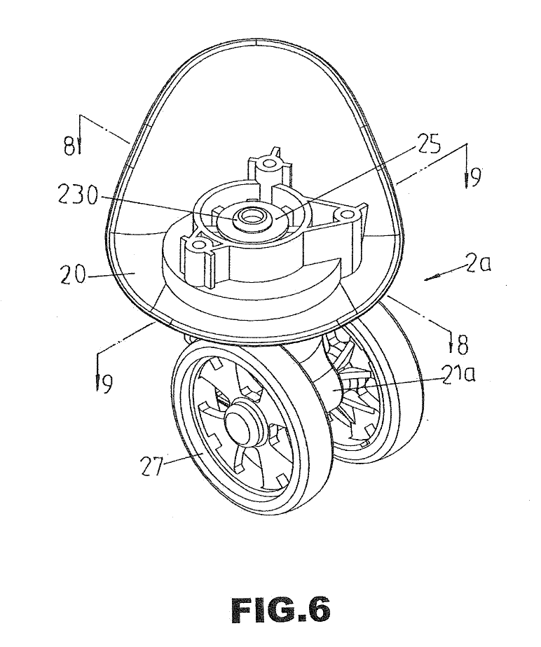

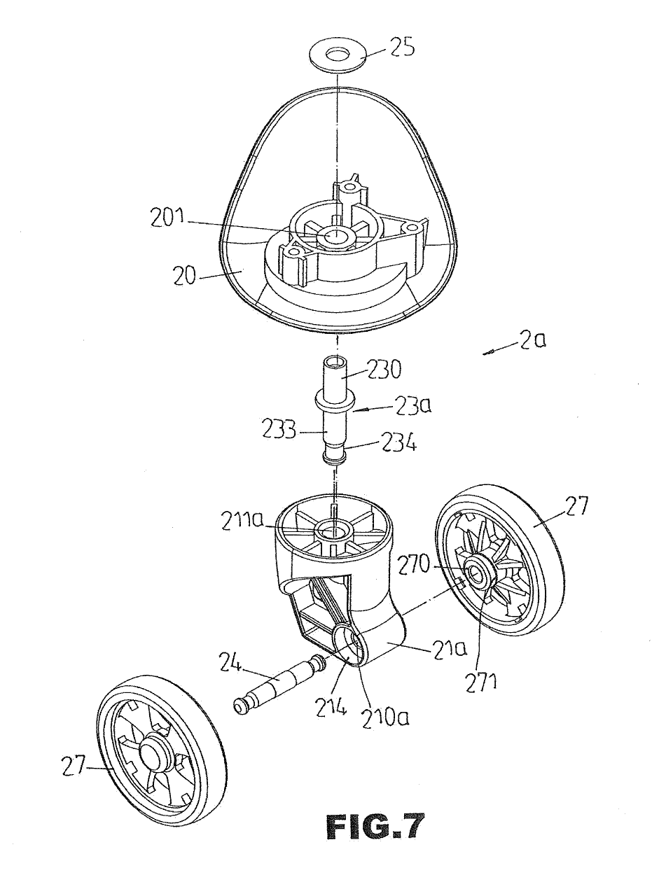

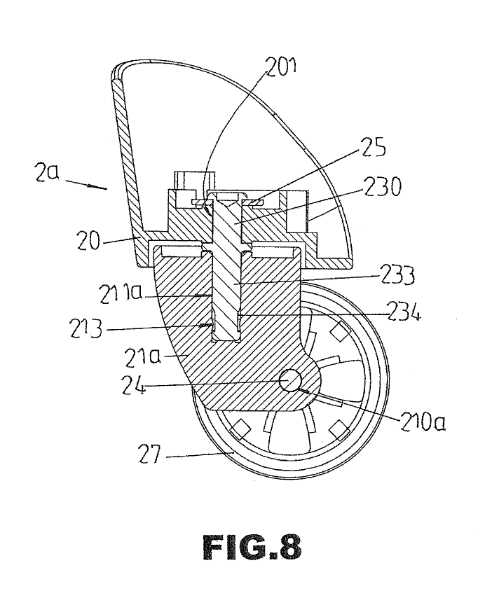

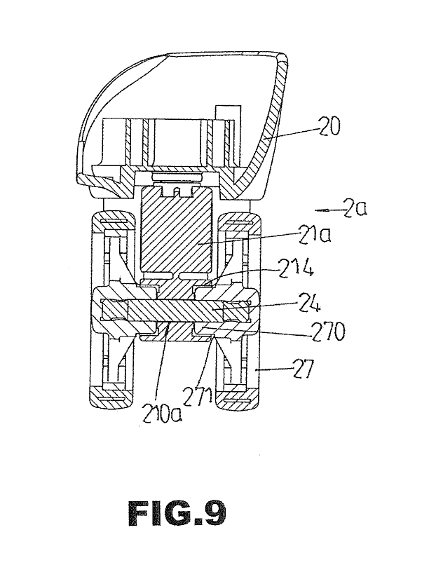

Referring to FIGS. 6-9, a castor 2a for a luggage in accordance with another preferred embodiment of the present invention comprises a mounting seat 20, an upright mandrel 23a having an upper portion 230 connected with the mounting seat 20, a roller support 21a mounted on a lower portion 233 of the upright mandrel 23a, a shaft 24 mounted on the roller support 21a, and two rollers 27 secured on two opposite ends of the shaft 24 and located at two opposite side of the roller support 21a.

The mounting seat 20 has a central portion provided with an upright through hole 201. The roller support 21a is provided with a shaft hole 210a which is extended in a transverse direction of the roller support 21a. The roller support 21a has a top provided with a receiving hole 211a which is extended in the vertical direction. The receiving hole 211a of the roller support 21a is provided with a flange 213. The flange 213 of the roller support 21a is formed on a lower portion of the receiving hole 211a and has an annular chamfered shape. Each of the two opposite side of the roller support 21a is provided with a mounting recess 214 connected to the shaft hole 210a. The shaft 24 is extended through the shaft hole 210a of the roller support 21a.

The upper portion 230 of the upright mandrel 23a is in turn extended through the through hole 201 of the mounting seat 20 and a washer 25. The upper portion 230 of the upright mandrel 23a is secured on the mounting seat 20 by riveting so that the upright mandrel 23a is combined with the mounting seat 20. The lower portion 233 of the upright mandrel 23a is inserted into the receiving hole 211a of the roller support 21a. The lower portion 233 of the upright mandrel 23a is provided with a groove 234 detachably locked onto the flange 213 of the roller support 21a. The groove 234 of the upright mandrel 23a is formed on a lower part of the lower portion 233 of the upright mandrel 23a and has an annular chamfered shape.

Each of the rollers 27 has an inner face provided with a stub 270 inserted into the respective mounting recess 214 of the roller support 21a. The stub 270 of each of the rollers 27 has a periphery provided with a stepped portion 271 abutting the respective mounting recess 214 of the roller support 21a, so that the stub 270 of each of the rollers 27 tightly seals the respective mounting recess 214 of the roller support 21a, and each of the rollers 27 is combined with the roller support 21a closely to prevent dust or dirt from entering the clearance between the roller support 21a and each of the rollers 27.

In assembly, the shaft 24 is initially extended through the shaft hole 210a of the roller support 21a. Then, the rollers 27 are secured on the two opposite ends of the shaft 24 and are located at the two opposite side of the roller support 21a. At this time, the stepped portion 271 of the stub 270 of each of the rollers 27 abuts the respective mounting recess 214 of the roller support 21a, so that the stub 270 of each of the rollers 27 seals the respective mounting recess 214 of the roller support 21a. Thus, each of the rollers 27 is combined with the roller support 21a tightly and closely to prevent dust or dirt from entering the clearance between the roller support 21a and each of the rollers 27.

Then, the upper portion 230 of the upright mandrel 23a is in turn extended through the through hole 201 of the mounting seat 20 and the washer 25, and is secured on the mounting seat 20 by riveting so that the upright mandrel 23a is combined with the mounting seat 20. Then, the lower portion 233 of the upright mandrel 23a is inserted into the receiving hole 211a of the roller support 21a, with the groove 234 of the upright mandrel 23 a being locked onto the flange 213 of the roller support 21a, so that the roller support 21a is combined with the upright mandrel 23a. At this time, the roller support 21a is rotatable relative to the upright mandrel 23a. In such a manner, the roller support 21a is combined with the mounting seat 20 by the upright mandrel 23a to construct the castor 2a.

When one of the rollers 27 is worn out, the user applies a force on the roller support 21a to pull the roller support 21a outward relative to the mounting seat 20, so as to detach the flange 213 of the roller support 21a from the groove 234 of the upright mandrel 23a, so that the roller support 21a can be detached and removed from the upright mandrel 23a for maintenance or replacement of the roller support 21a and the rollers 27.

Accordingly, the stepped portion 271 of the stub 270 of each of the rollers 27 abuts the respective mounting recess 214 of the roller support 21a, so that each of the rollers 27 is combined with the roller support 21a tightly and closely so as to prevent dust or dirt from entering the clearance between the roller support 21a and each of the rollers 27.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor for a luggage, comprising:
a mounting seat;
an upright mandrel having an upper portion connected with the mounting seat;
a roller support mounted on a lower portion of the upright mandrel;
a fastening member extended through the roller support and locked onto the lower portion of the upright mandrel to combine the roller support with the upright mandrel;
a shaft mounted on the roller support; and
two rollers secured on two opposite ends of the shaft and located at two opposite side of the roller support; wherein:
the mounting seat is provided with an upright through hole;
the roller support is provided with a shaft hole;
the roller support has a top provided with a receiving hole;
the roller support has a bottom provided with a screw bore which is connected to the receiving hole;
the shaft is extended through the shaft hole of the roller support;
the upper portion of the upright mandrel is extended through the through hole of the mounting seat and is secured on the mounting seat so that the upright mandrel is combined with the mounting seat;
the lower portion of the upright mandrel is inserted into the receiving hole of the roller support;
the lower portion of the upright mandrel is stopped by a bottom wall of the receiving hole of the roller support;
the lower portion of the upright mandrel is provided with a threaded recess aligning with the screw bore of the roller support; and
the fastening member is extended through the screw bore of the roller support and is screwed into the threaded recess of the upright mandrel so that the roller support is combined with the upright mandrel.

2. The castor for a luggage of claim 1, wherein the fastening member is locked onto the roller support and the upright mandrel.

3. The castor for a luggage of claim 1, wherein the screw bore of the roller support is located at a ,central portion of and coaxial with the receiving hole.

4. The castor for a luggage of claim 1, wherein the threaded recess of the upright mandrel is formed in a central portion of a bottom of the lower portion of the upright mandrel.

5. The castor for a luggage of claim 1, wherein each of the rollers has an outer face provided with an annular retaining groove for mounting a resilient gasket which is made of a soft material.

6. The castor for a luggage of claim 1, wherein the fastening member is a bolt.

7. A castor for a luggage, comprising:
a mounting seat;
an upright mandrel having an upper portion connected with the mounting seat;
a roller support mounted on a lower portion of the upright mandrel;
a shaft mounted on the roller support; and
two rollers secured on two opposite ends of the shaft and located at two opposite side of the roller support; wherein:
the mounting seat is provided with an upright through hole;
the roller support is provided with a shaft hole;
the roller support has a top provided with a receiving hole;
the receiving hole of the roller support is provided with a flange;
the shaft is extended through the shaft hole of the roller support;
the upper portion of the upright mandrel is extended through the through hole of the mounting seat, and is secured on the mounting seat so that the upright mandrel is combined with the mounting seat;
the lower portion of the upright mandrel is inserted into the receiving hole of the roller support;
the lower portion of the upright mandrel is provided with a groove detachably locked onto the flange of the roller support;
each of the two opposite side of the roller support is provided with a mounting recess connected to the shaft hole;
each of the rollers has an inner face provided with a stub inserted into the respective mounting recess of the roller support; and
the stub of each of the rollers has a periphery provided with a stepped portion abutting the respective mounting recess of the roller support, so that the stub of each of the rollers seals the respective mounting recess of the roller support, and each of the rollers is combined with the roller support closely.

8. (canceled)

9. The castor for a luggage of claim 7, wherein the flange of the roller support is formed on a lower portion of the receiving hole.

10. The castor for a luggage of claim 7, wherein the flange of the roller support has an annular chamfered shape.

11. The castor for a luggage of claim 7, wherein the groove of the upright mandrel is formed on a lower part of the lower portion of the upright mandrel.

12. The castor for a luggage of claim 7, wherein the groove of the upright mandrel has an annular chamfered shape.

13. The castor for a luggage of claim 1, wherein the screw bore of the roller support is located under the bottom wall of the receiving hole of the roller support.

14. The castor for a luggage of claim 1, wherein the screw bore of the roller support has a dimension smaller than that of the receiving hole of the roller support.

15. The castor for a luggage of claim 1, wherein the fastening member abuts the bottom of the roller support.

16. The castor for a luggage of claim 1, wherein the fastening member is detachable from the upright mandrel and the roller support.
